(19) United States
(12) Patent Application Publication
(10) Pub. No.: US 2025/0048413 A1
(43) Pub. Date: Feb. 6, 2025

(54) METHOD AND APPARATUS FOR PROVIDING COMMUNICATION SERVICE IN MOBILE COMMUNICATION SYSTEM COOPERATING WITH UAS

(71) Applicant: HYUNDAI MOBIS CO., LTD., Seoul (KR)

(72) Inventor: Dae Gon SON, Seoul (KR)

(73) Assignee: HYUNDAI MOBIS CO., LTD., Seoul (KR)

(21) Appl. No.: 18/679,837

(22) Filed: May 31, 2024

(30) Foreign Application Priority Data
Aug. 1, 2023 (KR) 10-2023-0100294

(51) Int. Cl. H04W 72/54; H04B 7/185; H04W 72/20

(52) U.S. Cl. CPC H04W 72/54; H04B 7/18504; H04W 72/20

(57) ABSTRACT

A method of receiving a communication service through a network by a user equipment (UE) in a mobile communication system cooperating with an uncrewed aerial system (UAS) and an apparatus therefor are provided. The method includes: receiving a first message including link configuration-related information from the network; acquiring first type information by the UE; receiving second type information from an external server by the UE; determining a quality level for configuring a command and control (C2) communication service link based on the link configuration-related information; and configuring the C2 communication service link with the network according to the determined quality level, wherein the quality level for configuring the C2 communication service link is determined based on at least one of the first type information, the second type information, or any combination thereof.

### CROSS-REFERENCE TO RELATED APPLICATION(S)

Pursuant to 35 U.S.C. § 119 (a), this application claims the benefit of an earlier filing date and right of priority to Korean Application No. 10-2023-0100294, filed on Aug. 1, 2023, in the Korean Intellectual Property Office, the entire contents of which are hereby incorporated by reference herein for all purposes.

### BACKGROUND

### 1. Field

The following description relates to a method of providing a communication service in a mobile communication system cooperating with an unmanned aerial system (UAS), and an apparatus therefor. Specifically, the following description relates to a method of providing a communication service by configuring a command and control (C2) communication service link according to a quality level set using sensing information of a user equipment (UE) and/or external server information, and an apparatus therefor.

### 2. Description of the Related Art

A wireless communication system has used various technologies such as LTE, LTE-advanced, and Wi-Fi, and 5G is also included in the technologies. Three key requirement areas of 5G include (1) enhanced mobile broadband (eMBB), (2) massive machine type communication (mMTC), and (3) ultra-reliable and low latency communication (URLLC) areas. Some use cases may require multiple areas for optimization, while others may focus only on one key performance indicator (KPI). 5G supports such diverse use cases in a flexible and reliable way.

Thereamong, URLLC includes new services which will transform industries through ultra-reliable/available, low latency links such as remote control of critical infrastructure and self-driving vehicles. The levels of reliability and latency are essential to smart-grid control, industrial automation, robotics, drone control and coordination.

The above-described URLLC technology may be a sort of method of providing important communication services with ultra-reliability and low latency. However, even in this case, there may be cases in which a link is disconnected for various reasons such as a poor channel state. In particular, there are limitations in stably providing important services not only in general vehicle communication but also in a high-speed, aerial situation such as a UAS.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

Embodiments of the present disclosure provide a method of providing a communication service according to a required quality level in a mobile communication system cooperating with a UAS, and an apparatus therefor.

Specifically, the embodiments of the present disclosure provide a method of providing a communication service by configuring a command and control (C2) communication service link according to a quality level set using sensing information of a user equipment (UE) and/or external server information, and an apparatus therefor.

Further, upon considering various deployment relationships of a UAS, the embodiments of the present disclosure configure an external server for efficiently determining the quality level of a UE in the UAS and define information obtained from the external server.

The objects to be achieved by the present disclosure are not limited to what has been particularly described hereinabove and other objects not described herein will be more clearly understood by persons skilled in the art from the following detailed description.

In a general aspect of the disclosure, a method of receiving a communication service through a network by a user equipment (UE) in a mobile communication system cooperating with an uncrewed aerial system (UAS), includes: receiving a first message including link configuration-related information from the network; acquiring first type information by the UE; receiving second type information from an external server by the UE; determining a quality level for configuring a command and control (C2) communication service link based on the link configuration-related information; and configuring the C2 communication service link with the network according to the determined quality level, wherein the quality level for configuring the C2 communication service link is determined based on at least one of the first type information, the second type information, or any combination thereof.

The first type information may include one or more of location, speed, acceleration, direction, and obstacle information of the UE.

The second type information may include operational environment information of the UE, and the external server may include a server of a vertiport.

The operational environment information may include corridor information of the UE and operational status information of the vertiport.

The operational status information of the vertiport may include one or more of congestion information of the vertiport and information related to an unauthorized aircraft in a corridor.

The determining of the quality level may include determining the quality level by additionally considering third type information including current operational status information of the UE.

The configuring of the C2 communication service link may include duplicating the C2 communication service link when the determined quality level is equal to or greater than a predetermined reference.

The configuring of the C2 communication service link may include: determining whether the first C2 communication service link configured based on the link configuration-related information satisfies the determined quality level; and reconfiguring the first C2 communication service link as a second C2 service link when the first C2 communication service link does not satisfy the determined quality level.

The UE may include an uncrewed aerial vehicle (UAV).

The mobile communication system may include a mobile communication service provider system cooperating with the UAS, and the UAS may include a UAV operator server for controlling the UAV and a UAV traffic management service providing server.

The UAS may further includes one or more of a UAV operational support information providing server, a vertiport operator server, and a UAV traffic control server, wherein the UAV traffic management service providing server may be configured to receive information from one or more of the UAV operational support information providing server, the vertiport operator server, and the UAV traffic control server.

The external server may include the UAV traffic management service providing server.

In another general aspect of the disclosure, a method of providing a communication service through a mobile communication system to a user equipment (UE) by an uncrewed aerial system (UAS) cooperating with the mobile communication system, may include: configuring a first command and control (C2) communication service link of the UE in cooperation with the mobile communication system; receiving first type information from the UE; acquiring second type information about the UE from an external server; determining a quality level required for the UE based on one or more of the first type information and the second type information; determining whether the first C2 communication service link needs to be reconfigured based on the determined quality level; and transmitting a reconfiguration request message of the first C2 communication service link to the mobile communication system in response to the determination that the first C2 communication service link needs to be reconfigured based on the determined quality level.

The reconfiguration request message of the first C2 communication service link may be used to configure a second C2 link with the UE by the mobile communication system.

The first type information may include one or more of location, speed, acceleration, direction, and obstacle information of the UE.

The second type information may include operational environment information of the UE, and the external server may include a server of a vertiport.

The operational environment information may include corridor information of the UE and operational status information of the vertiport.

The operational status information of the vertiport may include one or more of congestion information of the vertiport and information related to an unauthorized aircraft in a corridor.

In yet another general aspect of the disclosure, a user equipment (UE) for receiving a communication service through a network in a mobile communication system cooperating with an uncrewed aerial system (UAS), includes: at least one processor; and at least one computer memory operably connectable to the at least one processor and storing instructions that, when executed, cause the at least one processor to perform operations, wherein the operations includes: receiving a first message including link configuration-related information from the network; acquiring first type information by the UE; receiving second type information from an external server by the UE; determining a quality level for configuring a command and control (C2) communication service link based on the link configuration-related information; and configuring the C2 communication service link with the network according to the determined quality level, wherein the quality level for configuring the C2 communication service link is determined based on at least one of the first type information, the second type information, or any combination thereof.

In yet another general aspect of the disclosure, an uncrewed aerial system (UAS) cooperating with a mobile communication system and providing a communication service to a user equipment (UE) through the mobile communication system, includes: at least one processor; and at least one computer memory operably connectable to the at least one processor and storing instructions that, when executed, cause the at least one processor to perform operations, wherein the operations comprise: configuring a first command and control (C2) communication service link of the UE in cooperation with the mobile communication system; receiving first type information from the UE; acquiring second type information about the UE from an external server; determining a quality level required for the UE based on one or more of the first type information and the second type information; determining whether the first C2 communication service link needs to be reconfigured based on the determined quality level; and transmitting a reconfiguration request message of the first C2 communication service link to the mobile communication system in response to the determination that the first C2 communication service link needs to be reconfigured based on the determined quality level.

The reconfiguration request message of the first C2 communication service link may include information used by the mobile communication system to establish a second C2 link with the UE.

The information used by the mobile communication system to establish a second C2 link with the UE includes UAV identification information and corresponding quality information.

The effects that are achievable by the present disclosure are not limited to what has been particularly described hereinabove and other advantages not described herein will be more clearly understood by persons skilled in the art from the following description.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a diagram illustrating the concept of an unmanned aerial system (UAS);

FIG. 2 is a diagram illustrating a method of receiving a communication service by a UE according to an embodiment of the present disclosure;

FIG. 3 is a diagram illustrating supplementary information available for quality configuration in a mobile communication system cooperating with a UAS according to an embodiment of the present disclosure;

FIG. 4 is a diagram illustrating the configuration of a mobile communication network according to an embodiment of the present disclosure;

FIG. 5 is a diagram illustrating in more detail the configuration of a UAS in the mobile communication system illustrated in FIG. 4;

FIG. 6 is a diagram illustrating a method of determining a quality level for C2 communication by a UAS according to an embodiment of the present disclosure;

FIG. 7 is a diagram illustrating a method of performing C2 communication with a UE by a mobile communication network according to an embodiment of the present disclosure;

FIG. 8 is a diagram illustrating a method of performing C2 communication by a UE according to an embodiment of the present disclosure; and

FIG. 9 illustrates wireless devices applicable to the present technology.

### DETAILED DESCRIPTION

Hereinafter, embodiments of the present disclosure will be described in detail with reference to the accompanying drawings so that the present disclosure may be easily realized by those skilled in the art. However, the present disclosure may be achieved in various different forms and is not limited to the embodiments described herein. In the drawings, parts that are not related to a description of the present disclosure are omitted to clearly explain the present disclosure and similar reference numbers will be used throughout this specification to refer to similar parts.

In the specification, when a part “includes” an element, this means that the part may further include another element rather than excluding another element unless otherwise mentioned.

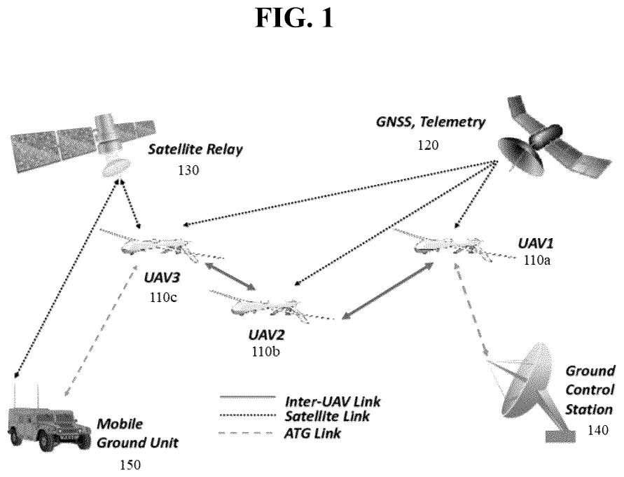

FIG. 1 is a diagram illustrating the concept of an unmanned aerial system (UAS).

As illustrated in FIG. 1, the UAS may include one or more uncrewed aerial vehicles (UAVs) 110a, 110b, and 110c (e.g., drones) and one or more ground control stations 140 (or ground control centers or ground control servers) that manage the UAVs.

The UAS may cooperate with a mobile communication service provider system for providing an efficient communication service to the UAV(s).

In the following description, a “mobile communication system” may conceptually include a mobile communication service provider system, operated by a conventional mobile communication service provider, and a UAS and may also mean, in a narrow sense, a mobile communication service provider system that is distinguished from the UAS. In this mobile communication system, a conventional mobile communication service and a UAS service may be defined by one communication standard specification (e.g., 3GPP standard specification).

Meanwhile, a network described below may operate to link the mobile communication service provider system with the UAS. That is, the network described later is assumed to include a network of the mobile communication service provider system and a network for the UAS.

The UAV 110a, 110b, and 110c may be used as a concept that collectively refers to unmanned aerial logistics and/or transportation capable of vertical takeoff and landing. However, this is purely one embodiment, and the UAVs 110a, 110b, and 110c according to another embodiment of the present disclosure may be used as a concept that further includes manned air logistics and/or transportation capable of vertical takeoff and landing.

The mobile communication system may be configured to include a network including a base station (BS) and a core network, and various user devices cooperating with the network. Hereinafter, for convenience of description, the various user devices cooperating with the network will be collectively referred to as “UEs”.

In an embodiment, the network may not only cooperate with the ground control station 140, but may also additionally cooperate with a global navigation satellite system (GNSS) 120 for providing location information and/or a satellite relay 130 for satellite communication.

In an embodiment, the UE may be equipped with a global positioning system (GPS) receiver and may receive signals directly from the GNSS 120 and/or the satellite relay 130.

A network according to another embodiment may be used as a concept including all of a BS, a core network, and the ground control station 140. In this case, the mobile communication system may be used as a concept including the UAS.

Meanwhile, UEs that receive communication services from the UAS may include a mobile ground unit 150 as well as the UAVs 110a, 110b, and 110c described above. That is, in the following description, the “UEs” are assumed to be the UAVs 110a, 110b, and 110c for convenience of description. However, the UEs are not limited thereto and do not exclude the case in which the UEs include the mobile ground unit 150 as illustrated in FIG. 1 or a general mobile phone/smartphone.

In FIG. 1, an inter-UAV link is established between the UAVs 110a, 110b, and 110c. The inter-VAU link may correspond to a sidelink of the 3rd generation partnership project (3GPP). The UASs 110a, 110b, and 110c may have a satellite link established with the satellite units 120 and 130 and may be connected to the ground units 140 and 150 through an air-to-ground (ATG) link.

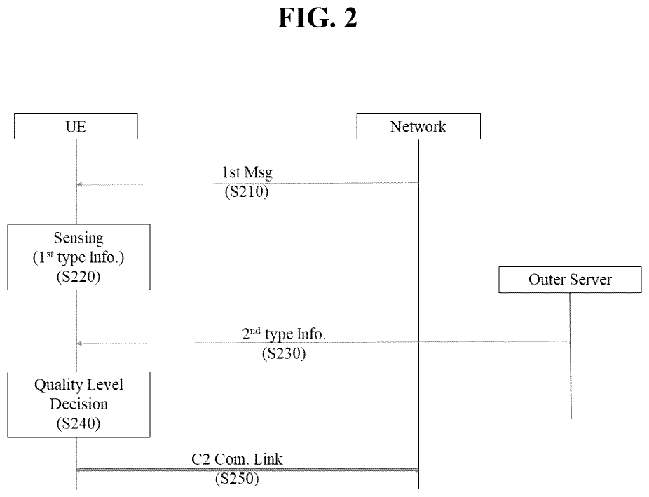

FIG. 2 is a diagram illustrating a method of receiving a communication service by a UE according to an embodiment of the present disclosure.

First, the UE may receive a first message including link configuration-related information from a network (S210). The link configuration-related information may include information for configuring a C2 communication service link and correspond to bearer configuration information in the communication standard.

The UE according to the present embodiment may additionally use information described below, in order to efficiently determine a quality level required for the C2 communication service link, in addition to the received link configuration-related information.

Specifically, as illustrated in FIG. 2, the UE may acquire first type information through sensing (S220) and/or receive second type information from an external server (S230).

Here, the first type information may include one or more of location, speed, acceleration, direction (e.g., movement path), and obstacle information of the UE. The second type information may include operational environment information of the UE. The operational environment information may include corridor information of the UE and operational status information of a vertiport. The operational status information of the vertiport may include one or more of congestion information of the vertiport and information related to unauthorized aircraft in a corridor. For this purpose, the external server may include a server of the vertiport.

Upon receiving the supplementary information, the UE may determine a quality level for configuring the C2 communication service link based on the link configuration-related information received in step S210 (S240). In this case, it is proposed that the quality level for configuring the C2 communication service link be determined based on one or more of the first type information and the second type information (S240). For example, for the C2 communication service link, efficient quality of service (QOS) for C2 communication may be configured by considering the corridor information of the UE and/or the information about the vertiport. An exemplary embodiment of the present disclosure proposes determining the quality level (S240) by additionally considering third type information including current operational status information of the UE (e.g., an operational standby status, a takeoff preparation status, a takeoff status, an operational status, a landing standby status, a landing status, etc.).

According to the quality level (e.g., QoS) determined in this way, the UE may configure the C2 communication service link with the network (S250).

In 3GPP mobile communication up to now, one bearer is configured and used for one specific service in a process of transmitting service data for one UE. However, in the embodiment, the ground control station 140 of the UAS may provide a C2 communication service for monitoring an operational status of the UAV in real time or remotely controlling the UAV through a ground network, and a method in which a network configures two or more bearers in one C2 communication service flow for an important communication service such as the C2 communication service is proposed.

In the present embodiment, the importance of the communication service may be determined based on at least one of a delay characteristic required for the service, a security characteristic (or level) required for the service, relevance to operation (or driving) safety, a data transmission error rate required for the service, and reliability of link maintenance required for the service. However, the importance of the communication service is not limited thereto and may be determined by additionally considering various service characteristics according to the design of those skilled in the art.

Configuring a radio bearer (RB) refers to a process of defining a radio protocol layer and a channel characteristic and configuring each specific parameter and operation method in order to provide a specific service. The RB may be further divided into a signaling radio bearer (SRB) and a data radio bearer (DRB). The SRB is used as a passage through which a radio resource control (RRC) message is transmitted on a control plane, and the DRB is used as a passage through which user data is transmitted on a user plane.

To this end, in a mobile communication system including a UAS (or cooperating with the UAS through a network), the UE receives the first message including bearer-related information, i.e., information for bearer configuration or reconfiguration, from the network (S210) and additionally receives the first type information (S220) and/or the second type information (S240), as illustrated in FIG. 2. Then, in performing an operation of configuring a bearer with the network based on the above information (S250), it is proposed to configure two or more RBs for the C2 communication service of the UAS, e.g., for one service flow/bearer/session for the C2 communication service.

Here, the first message may be an RRC reconfiguration message.

While the description of FIG. 2 has been given under the assumption that the first message (S210) is an RRC message, the present disclosure is not limited thereto, and the first message (S210) may be system information or a non-access stratum (NAS) message.

That is, through the NAS message (S210) received by the UE in a PDU session configuration or change procedure, the UE may be provided with a QoS rule that maps two or more DRBs to a QoS flow corresponding to a specific QoS flow identifier (QFI), and accordingly, the network may provide the C2 communication service through the two or more DRBs.

An RRC layer is defined only on the control plane. The RRC layer controls logical channels, transport channels, and physical channels in relation to configuration, reconfiguration, and release of RBs. An RB refers to a logical path provided by a first layer (a physical layer or PHY layer) and a second layer (a media access control (MAC) layer, a radio link control (RLC) layer, or a packet data convergence protocol (PDCP) layer), for data transmission between the UE and the network.

Once an RRC connection is established between the RRC layer of a UE and the RRC layer of a BS, the UE is in RRC_CONNECTED state, and otherwise, the UE is in RRC_IDLE state. In NR, RRC_INACTIVE state is additionally defined. A UE in the RRC_INACTIVE state may maintain a connection, i.e., a session, to a core network, while the UE may release a connection, e.g., a radio link, from the BS. Therethrough, the UE may receive a fast communication service by configuring a radio link as needed without performing a separate session configuration procedure in RRC_INACTIVE state.

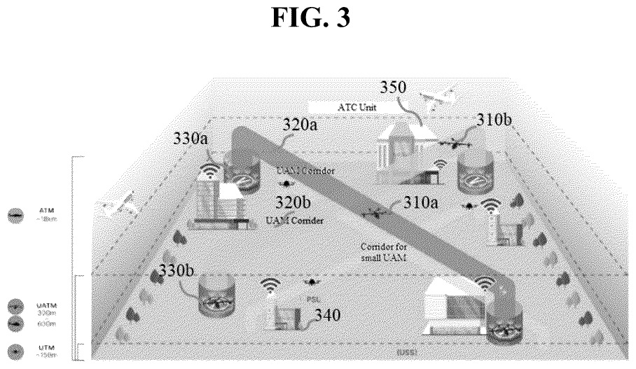

FIG. 3 is a diagram illustrating supplementary information available for quality configuration in a mobile communication system cooperating with a UAS according to an embodiment of the present disclosure.

In FIG. 3, an example is illustrated in which a plurality of UAVs 310a and 310b corresponding to UEs take off from corresponding respective vertiports 330a and 330b and operate through corridors 320a and 320b corresponding to determined operational routes.

The UAS includes a UAV (or urban air mobility (UAM)) traffic management service providing server (which may also be referred to as a provider of services for UAV (PSU)) 340. The UAV traffic management service providing server 340 may secure weather and climate condition information, obstacle and terrain information, vertiport availability information, real-time capacity change information (congestion), corridor departure detection information, unauthorized object detection information, etc. In this case, the corridor departure detection information and the unauthorized object detection information may be secured from a UAV traffic control server (which may also be referred to an air traffic control (ATC) unit) 350 illustrated in FIG. 3.

As described above, the first type information may include one or more of the location, speed, acceleration, direction (e.g., movement path), and obstacle information of the UE.

Additionally, in this UAS system, the second type information obtained from the external server may be information obtained from the UAV traffic management service providing server 340 and may include one or more of corridor information of the UE, congestion information of the vertiport, and information related to an unauthorized aircraft in a corridor.

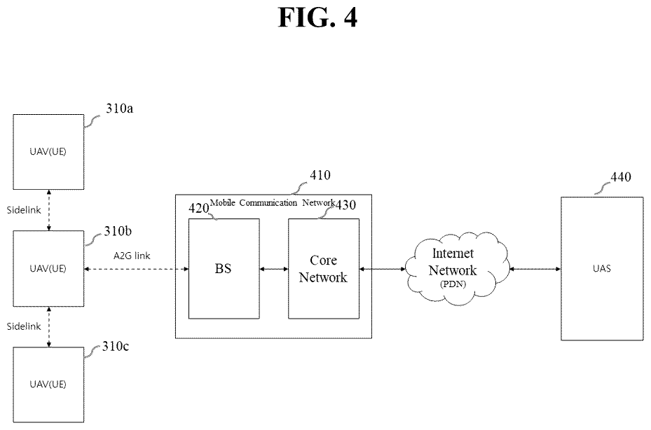

FIG. 4 is a diagram illustrating the configuration of a mobile communication network according to an embodiment of the present disclosure.

As illustrated in FIG. 4, a plurality of UEs may be UAVs 310a, 310b, and 310c, and communication between the UAVs 310a, 310b, and 310c may be performed through a sidelink. The specific UAV 310b may perform wireless communication with a mobile communication network 410 through a BS 420 which may be a ground station and a link between the UAV 310b and the BS may be an air-to-ground (A2G) link.

The mobile communication network 410 includes the BS 420 and a core network 430 and may be connected to a UAS 440 through an Internet network.

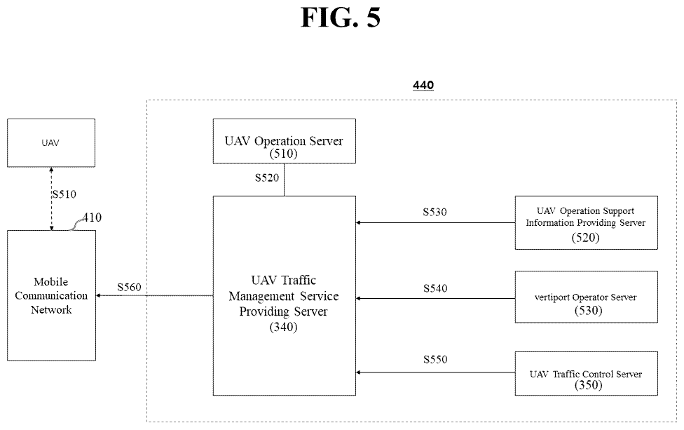

FIG. 5 is a diagram illustrating in more detail the configuration of a UAS in the mobile communication system illustrated in FIG. 4.

As described above, the mobile communication network 410 may be connected to the UAS 440 through the Internet network. The UAS 440 may include a server 510 of a UAV operator (hereinafter referred to as the UAV operation server 510) corresponding to an entity establishing a UAV flight plan and performing operation and management of an aircraft, and a server 340 of a UAV traffic management service provider (hereinafter referred to as the UAV traffic management service providing server 340) corresponding to an entity providing UAV operation safety information sharing, traffic flow management, flight planning approval, and route departure monitoring services. As illustrated in FIG. 5, the UAV traffic management service providing server 340 may receive flight plan/real-time operation information (passenger information), etc. from the UAV operation server 510 (S520).

In addition, the UAS 440 according to the embodiment may additionally include a UAV operation support information providing server 520, a vertiport operator server 530, and a UAV traffic control server 350, as illustrated in FIG. 5. As described above, the UAV traffic management service providing server 340 may receive weather and weather status information/obstacle and terrain information, etc. from the UAV operation support information providing server 520 (S530), receive vertiport availability information/real-time capacity change information (congestion level) from the vertiport operator server 530 (S540), and receive corridor departure detection information/unauthorized object detection information from the UAV traffic control server 350 (S550).

Upon receiving the above-described information, the UAV traffic management service providing server 340 may determine a quality level required for a C2 communication service based on this information and transmit a related message to the mobile communication network 410 (S560). In this case, the message that the UAV traffic management service providing server 340 transmits to the mobile communication network 410 may include a UAV identifier and corresponding required quality information in response to a quality request message for the C2 communication service.

Upon receiving the above information, the mobile communication network 410 may transmit a bearer configuration message for C2 communication to a corresponding UAV based on the received information to configure a C2 communication link (S510). That is, unlike the embodiment of FIG. 2, in the embodiment illustrated in FIG. 5, the UAV traffic management service providing server 340 of the UAS 440 may configure quality required for the C2 communication link by additionally considering first type information and/or second type information and provide the quality information to the mobile communication network 410. The mobile communication network 410 may configure the C2 communication link with the corresponding UAV based on the quality information.

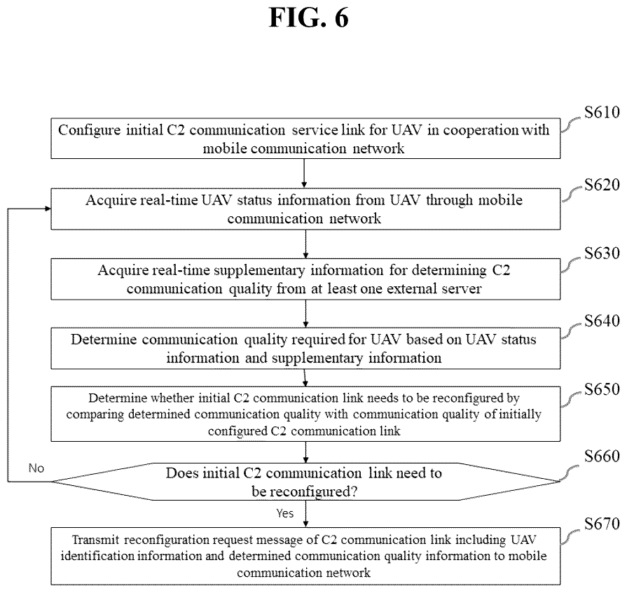

FIG. 6 is a diagram illustrating a method of determining a quality level for C2 communication by a UAS according to an embodiment of the present disclosure.

The UAS may first configure a first C2 communication service link of a UE (e.g., UAV) in cooperation with a mobile communication system (S610).

It is proposed that the UAS according to the embodiment obtain information about the UE and/or an external server in order to obtain the above-described information (first/second/third type information) described with reference to FIGS. 3 to 5. Specifically, the UAS may receive the first type information from the UE through sensing of the UE (S620). The UAS may obtain the first type information through the mobile communication network. Additionally, the UAS may acquire the second type information about the UE from the external server (S630). Here, the external server may be the UAV traffic management service providing server 340 described above with reference to FIG. 5. However, the external service is not limited thereto and may be various other external servers introduced with reference to FIGS. 3 and 4 as long as the servers easily obtain corridor information of the UE (UAV) or vertiport information.

Upon acquiring the information (the first type information and/or the second type information), the UAS may determine a quality level required for the UE based on the acquired information (S640). Based on the quality level determined in this way, the UAS may determine whether the first C2 link configured in step S610 needs to be reconfigured (S650). If it is determined that reconfiguration is necessary (S660), the UAS may transmit a reconfiguration request message of the first C2 link to the mobile communication system (S670).

In this case, the reconfiguration request message of the first C2 link may include information used by the mobile communication system to establish a second C2 link with the UE and include, for example, UAV identification information and quality information corresponding thereto.

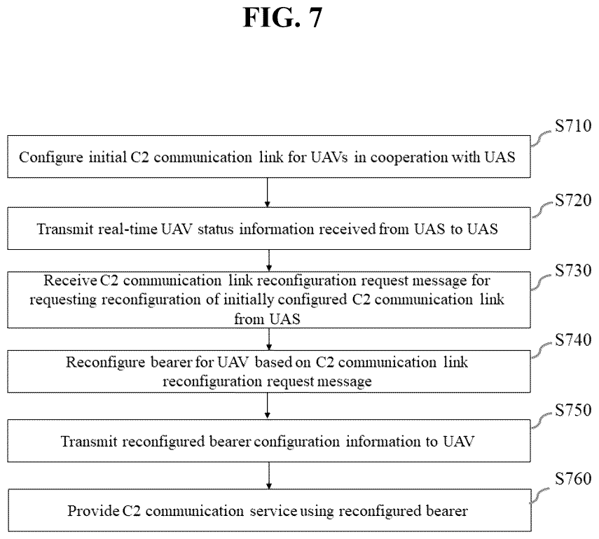

FIG. 7 is a diagram illustrating a method of performing C2 communication with a UE by a mobile communication network according to an embodiment of the present disclosure.

First, the mobile communication network may configure an initial C2 communication link (first C2 link) for one or more UAVs in cooperation with a UAS (S710). Additionally, the mobile communication network may transmit real-time UE status information received from the UE to the UAS so that the UAS may secure the UE status information (S720).

After transmitting such information, as described above with reference to FIG. 6, the mobile communication network may receive a reconfiguration request message for requesting reconfiguration of the first C2 link initially configured by the UAS from the UAS (S730). In this way, upon receiving the reconfiguration request message of the first C2 link, the mobile communication network may reconfigure a bearer for the corresponding UE (UAV) based on the received request message (S740).

The mobile communication network may transmit reconfigured bearer configuration information to the corresponding UE (UAV) (S750). Accordingly, the UE (UAV) and the mobile communication network may configure a second C2 link (S760). If congestion of a vertiport increases and thus high safety is required, the second C2 link may be configured by duplicating two or more bearers.

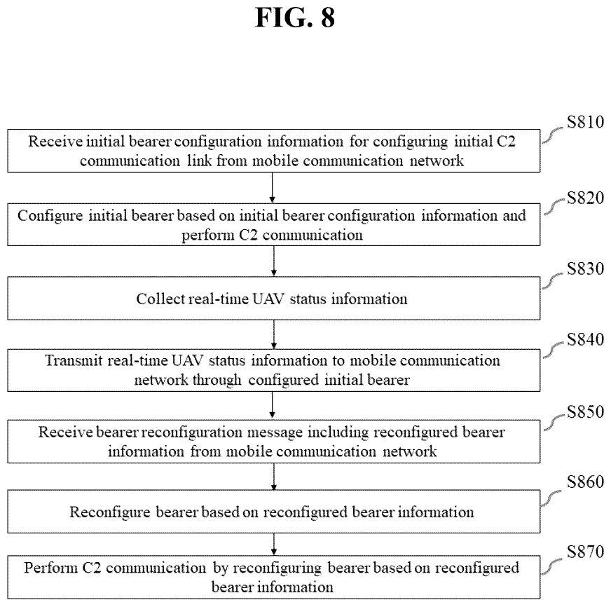

FIG. 8 is a diagram illustrating a method of performing C2 communication by a UE according to an embodiment of the present disclosure.

The UE (UAV) according to this embodiment may first receive initial bearer configuration information for configuring an initial C2 link (first C2 link) from a mobile communication network (S810). The UE may configure an initial bearer based on the initial bearer configuration information configured in this way and perform C2 communication through the initial bearer (S820).

Here, the UE (UAV) according to the embodiment may collect first type information including real-time status information (sensor information) of the UE (UAV) (S830) and transmit the real-time UAV status information collected through the configured initial bearer to the mobile communication network (S840). The collected real-time UAV status information may include not only channel status information (CSI), but also location information, speed information, acceleration information, heading information, altitude information, and failure status information, collected from various sensors.

The real-time status information of the UE (UAV) transmitted in this way may be used to determine the quality level required by the UAS as described above. The UAS may further consider external server information (second type information) of the UAS, in addition to this first type information, as described above.

As described above in FIGS. 6 and 7, if the UAS transmits the bearer reconfiguration message through the mobile communication network, the UE (UAV) may receive the bearer reconfiguration message from the mobile communication network (S850). Upon receiving the bearer reconfiguration message, the UE (UAV) may reconfigure a bearer based on the received information (S860) and perform C2 communication through the reconfigured bearer (S870).

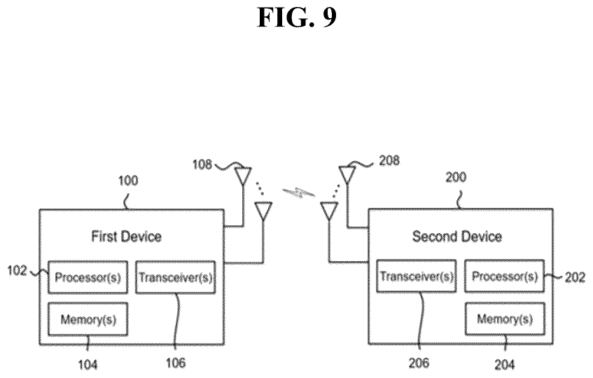

FIG. 9 illustrates a wireless device applicable to the present technology.

Referring to FIG. 9, a first wireless device 100 and a second wireless device 200 may transmit radio signals through various radio access technologies (RATs) (e.g., LTE and NR). Herein, the first wireless device 100 and the second wireless device 200 may correspond to the UE and the network in FIG. 2. Specifically, the first wireless device 100 and the second wireless device 200 may applied to various devices such as the UAS, the mobile communication network, and the UE, illustrated in FIGS. 3 to 5.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver(s) 106 and then store information acquired by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE E-UTRA or 5G NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with radio frequency (RF) unit(s). In the present disclosure, the wireless device may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 206 and then store information acquired by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE E-UTRA or 5G NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more protocol data units (PDUs) and/or one or more service data units (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. The descriptions, functions, procedures, proposals, methods, and/or operational flowcharts disclosed in this document may be implemented using firmware or software, and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process the received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

The above-described method and apparatus for providing a communication service in a mobile communication system cooperating with a UAS according to the embodiments of the present disclosure may be used in a communication system supporting an important service such as a C2 communication service of the UAS according to various communication protocols as well as 3GPP.

As described above, the detailed description of the exemplary embodiments of the present disclosure has been given to enable those skilled in the art to implement and practice the disclosure. Although the disclosure has been described with reference to the exemplary embodiments of the present disclosure, those skilled in the art will appreciate that various modifications and variations may be made in the present disclosure without departing from the spirit or scope of the disclosure. For example, those skilled in the art may use constructions disclosed in the above-described embodiments in combination with each other.

Accordingly, the present disclosure should not be limited to the specific embodiments described herein, but should be accorded the broadest scope consistent with the principles and features disclosed herein.

What is claimed is:

1. A method of receiving a communication service through a network by a user equipment (UE) in a mobile communication system cooperating with an uncrewed aerial system (UAS), the method comprising:
receiving a first message including link configuration-related information from the network;
acquiring first type information by the UE;
receiving second type information from an external server by the UE;
determining a quality level for configuring a command and control (C2) communication service link based on the link configuration-related information; and
configuring the C2 communication service link with the network according to the determined quality level,
wherein the quality level for configuring the C2 communication service link is determined based on at least one of the first type information, the second type information, or any combination thereof.

2. The method of claim 1, wherein the first type information includes one or more of location, speed, acceleration, direction, and obstacle information of the UE.

3. The method of claim 1,
wherein the second type information includes operational environment information of the UE, and
wherein the external server includes a server of a vertiport.

4. The method of claim 3, wherein the operational environment information includes corridor information of the UE and operational status information of the vertiport.

5. The method of claim 4, wherein the operational status information of the vertiport includes one or more of congestion information of the vertiport and information related to an unauthorized aircraft in a corridor.

6. The method of claim 1, wherein the determining of the quality level includes determining the quality level by additionally considering third type information including current operational status information of the UE.

7. The method of claim 1, wherein the configuring of the C2 communication service link includes duplicating the C2 communication service link when the determined quality level is equal to or greater than a predetermined reference.

8. The method of claim 1, wherein the configuring of the C2 communication service link includes:
determining whether the first C2 communication service link configured based on the link configuration-related information satisfies the determined quality level; and
reconfiguring the first C2 communication service link as a second C2 service link when the first C2 communication service link does not satisfy the determined quality level.

9. The method of claim 1, wherein the UE comprises an uncrewed aerial vehicle (UAV).

10. The method of claim 9,
wherein the mobile communication system includes a mobile communication service provider system cooperating with the UAS, and
wherein the UAS includes a UAV operator server for controlling the UAV and a UAV traffic management service providing server.

11. The method of claim 10,
wherein the UAS further includes one or more of a UAV operational support information providing server, a vertiport operator server, and a UAV traffic control server, and
wherein the UAV traffic management service providing server is configured to receive information from one or more of the UAV operational support information providing server, the vertiport operator server, and the UAV traffic control server.

12. The method of claim 11, wherein the external server comprises the UAV traffic management service providing server.

13. A method of providing a communication service through a mobile communication system to a user equipment (UE) by an uncrewed aerial system (UAS) cooperating with the mobile communication system, the method comprising:
configuring a first command and control (C2) communication service link of the UE in cooperation with the mobile communication system;
receiving first type information from the UE;
acquiring second type information about the UE from an external server;
determining a quality level required for the UE based on one or more of the first type information and the second type information;
determining whether the first C2 communication service link needs to be reconfigured based on the determined quality level; and
transmitting a reconfiguration request message of the first C2 communication service link to the mobile communication system in response to the determination that the first C2 communication service link needs to be reconfigured based on the determined quality level.

14. The method of claim 13, wherein the reconfiguration request message of the first C2 communication service link is used to configure a second C2 link with the UE by the mobile communication system.

15. The method of claim 13, wherein the first type information includes one or more of location, speed, acceleration, direction, and obstacle information of the UE.

16. The method of claim 15,
wherein the second type information includes operational environment information of the UE, and
wherein the external server includes a server of a vertiport.

17. The method of claim 16, wherein the operational environment information includes corridor information of the UE and operational status information of the vertiport.

18. The method of claim 17, wherein the operational status information of the vertiport includes one or more of congestion information of the vertiport and information related to an unauthorized aircraft in a corridor.

19. A user equipment (UE) for receiving a communication service through a network in a mobile communication system cooperating with an uncrewed aerial system (UAS), the UE comprising:
at least one processor; and
at least one computer memory operably connectable to the at least one processor and storing instructions that, when executed, cause the at least one processor to perform operations,
wherein the operations comprise:
receiving a first message including link configuration-related information from the network;
acquiring first type information by the UE;
receiving second type information from an external server by the UE;
determining a quality level for configuring a command and control (C2) communication service link based on the link configuration-related information; and
configuring the C2 communication service link with the network according to the determined quality level,
wherein the quality level for configuring the C2 communication service link is determined based on at least one of the first type information, the second type information, or any combination thereof.

20. An uncrewed aerial system (UAS) cooperating with a mobile communication system and providing a communication service to a user equipment (UE) through the mobile communication system, the UAS comprising:
at least one processor; and
at least one computer memory operably connectable to the at least one processor and storing instructions that, when executed, cause the at least one processor to perform operations,
wherein the operations comprise:
configuring a first command and control (C2) communication service link of the UE in cooperation with the mobile communication system;
receiving first type information from the UE;
acquiring second type information about the UE from an external server;
determining a quality level required for the UE based on one or more of the first type information and the second type information;
determining whether the first C2 communication service link needs to be reconfigured based on the determined quality level; and
transmitting a reconfiguration request message of the first C2 communication service link to the mobile communication system in response to the determination that the first C2 communication service link needs to be reconfigured based on the determined quality level.
